(19) United States
(12) Patent Application Publication
(10) Pub. No.: US 2026/0331325 A1
(43) Pub. Date: Oct. 22, 2026

(54) Radioisotope Power System

(71) Applicant: Adam Denoto, Brook Park, OH (US)

(72) Inventor: Adam Denoto, Brook Park, OH (US)

(21) Appl. No.: 19/254,318

(22) Filed: Jun. 30, 2025

Related U.S. Application Data
(60) Provisional application No. 63/792,364, filed on Apr. 22, 2025.

(51) Int. Cl. G21H 1/02

(52) U.S. Cl. CPC G21H 1/02

(57) ABSTRACT

An auxiliary power nuclear battery for providing continuous electrical energy in extreme planetary environments, such as the surface of, for example, Mars is disclosed. The battery includes a sealed, durable outer shell composed of boron carbide and tungsten alloy to protect against temperature extremes, dust, and micro-meteorite impacts. A multi-isotope fuel core is enclosed inside the outer shell and comprises fertile Thorium-232, short-active Thorium-228, fissile Uranium-233, and neutron-emitting Californium-252. Californium-252 emits neutrons to transmute Thorium-232 into Uranium-233, which undergoes sustained fission to release thermal and beta energy. Thorium-228 provides initial activation energy for rapid startup. A diamond-laced betavoltaic array captures beta particles and converts them into direct-current electricity. A gallium-indium liquid-metal cooling system manages thermal output. The system includes at least one graphene-coated power terminal capable of outputting energy in either continuous or pulsed form, based on connected load requirements.

### CROSS REFERENCE TO RELATED APPLICATION

The present application claims priority to, and the benefit of, U.S. Provisional Application No. 63/792,364 which was filed on Apr. 22, 2025 and is incorporated herein by reference in its entirety.

### FIELD OF THE INVENTION

The present invention generally relates to the field of autonomous energy systems. More specifically, the present invention relates to a compact, maintenance-free nuclear battery configured for long-term power generation in extreme planetary environments, such as the surface of, for example, Mars. The nuclear battery features a multi-isotope fuel core comprising Thorium-232, Thorium-228, Uranium-233, and Californium-252, designed to initiate and sustain fission-based energy conversion. A diamond-laced beta voltaic array captures beta particles generated by radioactive decay and converts them into continuous direct-current electricity. The device further includes a liquid-metal cooling system for thermal regulation and graphene-coated power terminals for high-efficiency energy transfer. The battery is encased in a boron carbide-tungsten shell for protection and insulation against dust, temperature extremes, and micro-meteorite impacts. Accordingly, the present disclosure makes specific reference thereto. Nonetheless, it is to be appreciated that aspects of the present invention are also equally applicable to other like applications, devices, and methods of manufacture.

### BACKGROUND

By way of background, Mars has emerged as a primary target for future human colonization due to its relative proximity to Earth, the presence of subsurface water ice, and its day-night cycle, which is similar in duration to Earth's. Many government space agencies and private entities are investing in Mars missions aimed at long-term scientific exploration and establishing permanent human settlements.

However, Mars presents an energy-deficient environment. The planet receives only about 43% of the solar energy that Earth does, limiting the efficiency of solar power systems. Moreover, seasonal and global dust storms can persist for weeks or months, further obstructing sunlight and rendering solar energy systems unreliable.

Standard chemical batteries are effective on Earth but are poorly suited to Mars due to extreme surface temperatures that can drop to −140 °C. Under such conditions, traditional batteries often freeze, degrade, or fail entirely. Other conventional power systems, such as combustion engines or fuel-based generators, require refueling, ongoing maintenance, and human oversight, however such conditions are incompatible with long-duration autonomous missions or early-stage colonization efforts.

Currently, there is no power source available that is capable of supporting serious industrial activity such as melting ice for water, generating breathable atmosphere, or powering large-scale terraforming equipment on Mars. The lack of a reliable, long-duration, and maintenance-free power solution limits the viability of sustained operations and the establishment of a self-sufficient human presence on the Martian surface. Accordingly, individuals desire a compact, durable, autonomous battery system that can operate independently under Martian environmental conditions.

Therefore, there exists a long-felt need in the art for an autonomous, long-duration power source capable of operating in the extreme environmental conditions of, for example, Mars. There is a long-felt need for a power system that is not dependent on solar irradiance. In addition, there is a long-felt need for a battery system that does not freeze or degrade under Martian temperatures, which can fall below −140 °C, and which does not require ongoing human oversight, refueling, or maintenance. Furthermore, there is a long-felt need for a compact and rugged auxiliary power unit capable of supporting continuous operation. There is also a long-felt need for a battery that generates electrical power continuously to power heavy equipment such as ice-melting systems, heaters, pumps, and other terraforming machinery. Finally, there is a long-felt need in the art for a nuclear battery that is safe, efficient, and capable of delivering stable electrical energy over multi-year timeframes in isolated, resource-scarce extraterrestrial environments.

The subject matter disclosed and claimed herein, in one embodiment, comprises an auxiliary power nuclear battery configured for autonomous use in planetary environments such as Mars. The nuclear battery includes a sealed outer shell formed from boron carbide and tungsten alloy, capable of withstanding extreme thermal conditions, dust intrusion, and micrometeorite impacts. The battery houses a multi-isotope fuel core comprising approximately 20 kg of Thorium-232, 3 kg of Thorium-228, 2 kg of Uranium-233, and 5 mg of Californium-252. The Californium-252 emits neutrons, which convert or transmute Thorium-232 into Uranium-233, enabling for sustained fission reactions. Thorium-228 provides an initial burst of decay energy to facilitate a rapid startup without external input. A diamond-laced beta voltaic array surrounds the fuel core and is configured to capture beta particles and convert them into direct-current electricity, with an efficiency of 10-15%. A gallium-indium liquid metal cooling system circulates thermal energy away from the core, preventing overheating even in vacuum or thin atmospheres. The battery includes one or more graphene-coated power terminals that regulate power output and enable secure connection to external systems.

In this manner, the auxiliary power nuclear battery of the present invention satisfies the long-felt need for a robust, maintenance-free power solution specifically designed for Mars exploration and colonization. The invention provides a self-contained, high-efficiency energy source capable of long-term, uninterrupted operation in sunlight-deficient, sub-zero, and dust-prone environments. The battery system enables the deployment of critical scientific, life-support, and industrial equipment without dependency on surface conditions or resupply missions. The battery offers a way to create a usable source of energy for human originated machine consumption despite lower solar ratings and limited visibility in the respective atmosphere.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an auxiliary power nuclear battery for use in planetary environments is disclosed. The battery comprises an outer shell made from a boron carbide-tungsten alloy, a fuel core is enclosed within the outer shell, the fuel core comprises a first predetermined quantity of a radioisotope fertile material, a second predetermined quantity of a short-lived radioisotope, a third predetermined quantity of a fissile material, and a fourth predetermined quantity of neutron-emitting radioisotope. A beta voltaic array is disposed about the fuel core and is configured to capture beta particles emitted during radioactive decay of the fuel core and convert the beta particles into direct-current electrical energy. A cooling system is configured to circulate a gallium-indium liquid metal alloy through thermal channels proximate the fuel core to absorb and dissipate waste heat. At least one graphene-coated connector terminal extends through the outer shell for transferring the electrical energy to one or more external loads.

In another aspect, an auxiliary power nuclear battery is disclosed. The battery comprises an outer housing fabricated from a boron carbide-tungsten alloy and sealed against dust and micrometeoroid ingress. A multi-isotope fuel core is enclosed within the housing and comprises Thorium-232, Thorium-228, Uranium-233, and Californium-252. A beta voltaic converter surrounds the fuel core for converting beta emissions into electrical current. A liquid-metal cooling subsystem provides thermal regulation. An intelligent graphene-coated power terminal is configured to monitor the electrical load of a connected device and automatically switch the battery output between continuous direct current mode and pulsed-power mode based on the monitored load requirements.

In another embodiment, a method of generating continuous electrical power in a harsh planetary environment using a nuclear battery is described. The method includes the steps of emitting free neutrons from a neutron-emitting isotope such as Californium-252, decaying a short-lived radioisotope comprising Thorium-228 to provide initial thermal energy and alpha radiation, bombarding a fertile nuclear material comprising Thorium-232 with the free neutrons to induce transmutation of Thorium-232 into Uranium-233, sustaining a controlled fission reaction of the Uranium-233 to release both thermal energy and beta particles, absorbing the thermal energy via a liquid-metal cooling system comprising a gallium-indium alloy, capturing the beta particles with a beta voltaic array to generate direct-current electrical energy, and routing the direct-current electrical energy through a connector terminal to at least one external electrical device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of nuclear battery of the present invention in accordance with the disclosed structure;

FIG. 2 illustrates a cross-sectional view of the auxiliary power nuclear battery of the present invention in accordance with the disclosed structure; and

FIG. 3 illustrates a flow diagram describing the process of generating electric power using the auxiliary power nuclear battery of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an autonomous, long-duration power source capable of operating in the extreme environmental conditions of, for example, Mars. There is a long-felt need for a power system that is not dependent on solar irradiance. In addition, there is a long-felt need for a battery system that does not freeze or degrade under Martian temperatures, which can fall below −140 °C, and which does not require ongoing human oversight, refueling, or maintenance. Furthermore, there is a long-felt need for a compact and rugged auxiliary power unit capable of supporting continuous operation. There is also a long-felt need for a battery that generates electrical power continuously to power heavy equipment such as ice-melting systems, heaters, pumps, and other terraforming machinery. Finally, there is a long-felt need in the art for a nuclear battery that is safe, efficient, and capable of delivering stable electrical energy over multi-year timeframes in isolated, resource-scarce extraterrestrial environments.

The present invention, in one exemplary embodiment, is an auxiliary power nuclear battery. The battery comprises an outer housing fabricated from a boron carbide-tungsten alloy and sealed against dust and micrometeoroid ingress. A multi-isotope fuel core is enclosed within the housing and comprises Thorium-232, Thorium-228, Uranium-233, and Californium-252. A betavoltaic converter surrounds the fuel core for converting beta emissions into electrical current. A liquid-metal cooling subsystem provides thermal regulation. An intelligent graphene-coated power terminal is configured to monitor the electrical load of a connected device and automatically switch the battery output between continuous direct current mode and pulsed-power mode based on the monitored load requirements.

Reference will now be made in detail to the present preferred embodiments of the invention, examples of which are illustrated in the accompanying drawings. Wherever possible, the same reference numerals are used in the drawings and the description to refer to the same or like parts.

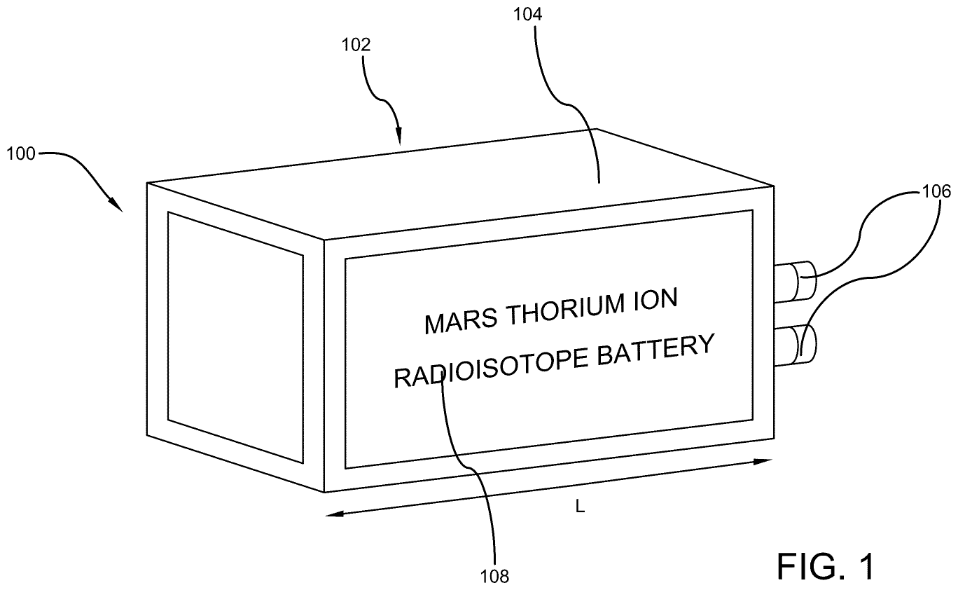

Referring initially to the drawings, FIG. 1 illustrates a perspective view of one potential embodiment of nuclear battery of the present invention in accordance with the disclosed structure. The nuclear battery 100 of the present invention is an auxiliary power source designed for long-term operations in harsh environments, for example a Martian environment. The nuclear battery 100 is compact and durable and has a long operational lifespan without requiring human intervention. Further, the auxiliary power nuclear battery 100 does not depend on solar energy, wind energy, or any other similar source, therefore, can be used in dust storms and polar shadow regions such as found on Mars.

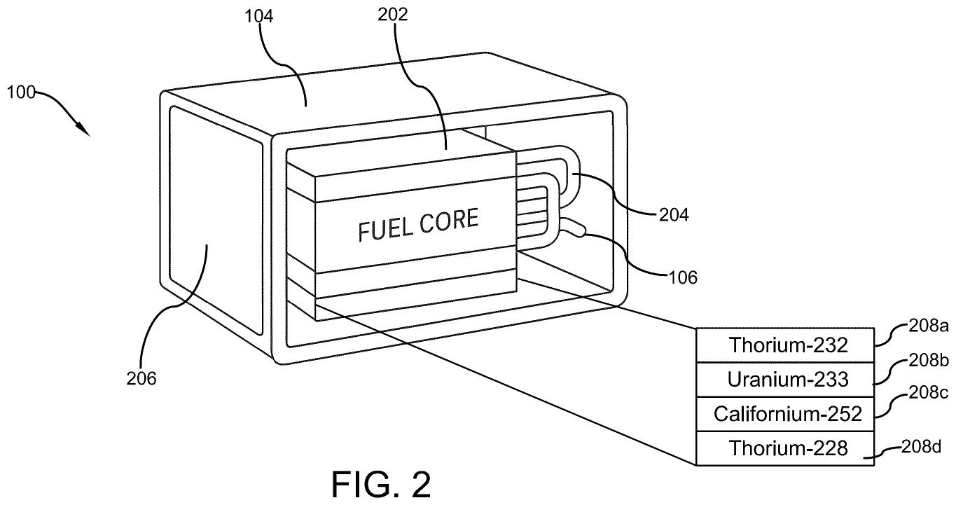

The auxiliary power nuclear battery 100 has a generally rectangular body 102. The body 102 can also be made in any geometric shape as per the manufacturing requirements of users of the auxiliary power nuclear battery 100. The nuclear battery 100 has a longitudinal length “L” in the range from about 30 cm to about 50 cm. An outer shell 104 of the body 102 is made of a material that provides protection and insulation against dust, micro-meteorites, and extreme temperatures such as in the range from about −140 °C to about +140 °C Preferably, the outer shell 104 is made of boron carbide and tungsten alloy. The outer shell 104 is sealed and encloses a fuel core (shown in FIG. 2) therein. Using the fuel core, the auxiliary power nuclear battery 100 is configured to generate electric power of about 10 kilowatt-hours (kWh) continuously. In one embodiment, the outer shell 104 may include boron nitride nanostructures that increase neutron absorption for a safe operation of the nuclear battery 100.

The auxiliary power nuclear battery 100 may include at least one graphene-coated connector terminal 106 for enabling the nuclear battery 100 to connect to one or more external devices or systems. The connector 106 is configured to regulate output power from the nuclear battery 100, enabling the nuclear battery 100 to be easily used with different devices. A logo or indicia 108 is disposed on the outer shell 104 for branding and marketing purposes and to indicate that the nuclear battery 100 is adapted for use on Mars.

FIG. 2 illustrates a cross-sectional view of the auxiliary power nuclear battery of the present invention in accordance with the disclosed structure. The auxiliary power nuclear battery 100 includes a fuel core 202 which includes a radioisotope mixture for nuclear decay and electric energy generation. The fuel core 202 includes a fertile nuclear material 208a such as 20 kg Thorium-232 which functions as the primary energy source for the nuclear battery 100. Thorium-232 is not fissile on its own and is not easily weaponized. Thorium-232 is adapted to convert into fissile Uranium-233 when bombarded with neutrons.

The fuel core 202 also includes a predetermined quantity such as 3 kg of Thorium-228 208d. Thorium-228 is a short-lived isotope and provides initial burst of nuclear activity inside the battery 100. Thorium-228 enables the nuclear battery 100 a quick startup without requiring external power input. Thorium-228 helps initially create Uranium-233 from Thorium-232.

A predetermined quantity radioactive material 208b such as 2 kg of Uranium-233 is included in the fuel core 202 and helps in sustaining the long-term fission reaction, releasing energy consistently over time. Uranium-233 produces high amounts of energy with small mass and is further, stable and safer than Uranium-235.

The fuel core 202 includes a predetermined quantity such as 5 mg of neutron-emitting radioisotope 208c “Californium-252”. Californium-252 provides free neutrons to convert or transmute Thorium-232 into Uranium-233. A small quantity of Californium-252 is supplied as Californium-252 has effective neutron output and can emit about two million neutrons per second per microgram. It should be noted that the Californium-252 converts the fertile Thorium-232 into fissile Uranium-233.

A betavoltaic array 204, preferably a diamond-laced Betavoltaic array is included in the nuclear battery 100 and is configured to capture beta particles generated in the beta decay of the radioisotopes. The betavoltaic array 204 converts the captured beta particles into electricity and can produce up to 10 kWh electrical energy at an efficiency in the range from about 10% to about 15%.

A cooling system 206 included in the nuclear battery 100 provides heat transfer by absorbing and distributing thermal energy. The cooling system 206 is preferably made of Gallium-Indium liquid metal and prevents overheating of the nuclear battery 100 during use. The cooling system 206 is non-freezing and is highly thermally conductive in Martian cold such as at −140 °C.

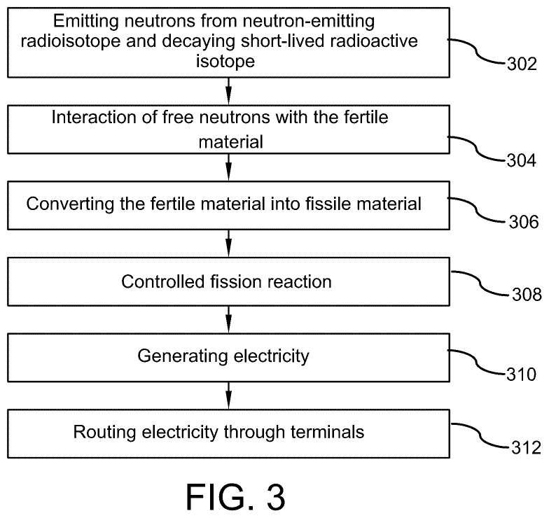

FIG. 3 illustrates a flow diagram describing the process of generating electric power using the auxiliary power nuclear battery of the present invention in accordance with the disclosed structure. Initially, free neutrons are emitted from the neutron-emitting radioisotope, such as Californium-252 and concurrently, the short-lived radioactive isotope Thorium-228, begins to decay (Step 302).

The free neutrons from the neutron-emitting radioisotope interact with the main fertile material Thorium-232 of the nuclear battery (Step 304). On absorbing neutrons, Thorium-232 is converted into Uranium-233, which is a fissile isotope and provides the long-term fuel cycle (Step 306). Then, Uranium-233 undergoes controlled nuclear fission, releasing both thermal energy and beta particles (Step 308). The fission process sustains the power generation over extended periods.

The diamond-laced betavoltaic arrays capture beta particles emitted during radioactive decay and convert the kinetic energy of the beta emissions into direct current electricity (Step 310). Finally, the generated electrical power is routed through graphene-coated power terminals to external devices, equipment, or storage units (Step 312). The terminals are configured for providing maximum conductivity and environmental durability.

In some embodiments, the nuclear battery 100 automatically switches between direct current (DC) output and pulsed output. The graphene-coated connector terminal 106 can monitor load requirement of a load connected to the battery 100 and the battery 1100 automatically switches the electric power.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “auxiliary nuclear battery”, “auxiliary power nuclear battery”, “nuclear battery”, “self-sustaining radioisotope power system”, and “battery” are interchangeable and refer to the self-sustaining radioisotope power system 100 of the present invention.

Notwithstanding the foregoing, the self-sustaining radioisotope power system 100 of the present invention can be of any suitable configuration as is known in the art without affecting the overall concept of the invention, provided that it accomplishes the above stated objectives. One of ordinary skill in the art will appreciate that the self-sustaining radioisotope power system 100 as shown in the FIGS. are for illustrative purposes only, and that many other configurations of the self-sustaining radioisotope power system 100 are well within the scope of the present disclosure. Although the dimensions of the self-sustaining radioisotope power system 100 are important design parameters for user convenience, the self-sustaining radioisotope power system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A nuclear power source comprising:
a nuclear battery having an outer shell, a fuel core, and a betavoltaic array;
wherein said fuel core enclosed and sealed within said outer shell;
wherein said fuel core having a radioisotope mixture comprising a radioisotope fertile material, a short-lived radioisotope, a fissile material, and a neutron-emitting radioisotope; and
further wherein said outer shell having a material selected from the group consisting of a boron carbide and a tungsten alloy.

2. The nuclear power source of claim 1, wherein said outer shell having a boron nitride nanostructure for increasing neutron absorption for operation of said nuclear battery.

3. The nuclear power source of claim 1, wherein said nuclear battery having at least one graphene-coated connector terminal for enabling said nuclear battery to connect to one or more external devices.

4. The nuclear power source of claim 3, wherein said at least one graphene-coated connector regulates output power from said nuclear battery.

5. The nuclear power source of claim 1, wherein said radioisotope fertile material is Thorium-232, the short-lived radioisotope is Thorium-228, the fissile material is Uranium-233, the neutron-emitting radioisotope is Californium-252, and further wherein said radioisotope mixture provides for nuclear decay and electric energy generation.

6. The nuclear power source of claim 5, wherein said Thorium-228 creates Uranium-233 from said Thorium-232, and further wherein said Californium-252 provides free neutrons to convert said Thorium-232 into said Uranium-233.

7. The nuclear power source of claim 6, wherein said betavoltaic array is a diamond-laced said betavoltaic array to capture beta particles generated in a beta decay of the radioisotopes.

8. The nuclear power source of claim 6, wherein said betavoltaic array converts the captured beta particles into electricity to produce electrical energy at an efficiency in the range from 10% to 15%.

9. The nuclear power source of claim 8, wherein said outer shell having a cooling system for providing heat transfer by absorbing and distributing thermal energy from said fuel core.

10. The nuclear power source of claim 9, wherein said cooling system having a material of Gallium-Indium liquid metal.

11. A nuclear power source comprising:
a nuclear battery having an outer shell, a fuel core, and a betavoltaic array;
wherein said fuel core enclosed and sealed within said outer shell;
wherein said fuel core having a radioisotope mixture comprising a radioisotope fertile material, a short-lived radioisotope, a fissile material, and a neutron-emitting radioisotope;
wherein said radioisotope fertile material is Thorium-232;
wherein said short-lived radioisotope is Thorium-228;
wherein said fissile material is Uranium-233;
wherein said neutron-emitting radioisotope is Californium-252; and
further wherein said radioisotope mixture provides for nuclear decay and electric energy generation.

12. The nuclear power source of claim 11, wherein said outer shell having a material selected from the group consisting of a boron carbide and a tungsten alloy, and further wherein said outer shell having a boron nitride nanostructure for increasing neutron absorption for operation of said nuclear battery.

13. The nuclear power source of claim 11, wherein said nuclear battery having at least one graphene-coated connector terminal for enabling said nuclear battery to connect to one or more external devices, and further wherein said at least one graphene-coated connector regulates output power from said nuclear battery.

14. The nuclear power source of claim 11, wherein said Thorium-228 creates Uranium-233 from said Thorium-232, and further wherein said Californium-252 provides free neutrons to convert said Thorium-232 into said Uranium-233.

15. The nuclear power source of claim 11, wherein said betavoltaic array is a diamond-laced said betavoltaic array to capture beta particles generated in a beta decay of the radioisotopes, and further wherein said betavoltaic array converts the captured beta particles into electricity to produce electrical energy at an efficiency in the range from 10% to 15%.

16. The nuclear power source of claim 11, wherein said outer shell having a cooling system for providing heat transfer by absorbing and distributing thermal energy from said fuel core, and further wherein said cooling system having a material of Gallium-Indium liquid metal.

17. A method of generating electric power using an auxiliary power nuclear battery, the method comprising the steps of:
providing a nuclear battery having an outer shell, a fuel core, and a betavoltaic array;
sealing said fuel core within said outer shell;
providing a radioisotope mixture in said fuel core including a radioisotope fertile material, a short-lived radioisotope, a fissile material, and a neutron-emitting radioisotope;
decaying of said short-lived radioisotope within said radioisotope mixture;
emitting free neutrons from said neutron-emitting radioisotope;
capturing decayed said short-lived radioisotopes with said betavoltaic array; and
generating electric power.

18. The method of generating electric power using an auxiliary power nuclear battery of claim 17, wherein said outer shell having a material selected from the group consisting of a boron carbide and a tungsten alloy, and further wherein said outer shell having a boron nitride nanostructure for increasing neutron absorption for operation of said nuclear battery.

19. The method of generating electric power using an auxiliary power nuclear battery of claim 17, wherein said radioisotope fertile material is Thorium-232, wherein said short-lived radioisotope is Thorium-228, wherein said fissile material is Uranium-233, wherein said neutron-emitting radioisotope is Californium-252.

20. The method of generating electric power using an auxiliary power nuclear battery of claim 19, wherein said Thorium-228 creates Uranium-233 from said Thorium-232, and further wherein said Californium-252 provides free neutrons to convert said Thorium-232 into said Uranium-233.
